(19) United States
(12) Patent Application Publication
(10) Pub. No.: US 2004/0132842 A1
(43) Pub. Date: Jul. 8, 2004

(54) System and method for recycling scrap fiberglass products in concrete and asphalt construction

(76) Inventors: Darrin Coffey, Danville, IN (US); Mark Sanders, Zionsville, IN (US); Gregory Steuerwald, Avon, IN (US)

Correspondence Address: MAGINOT, ADDISON & BOWMAN, BANK ONE CENTER/TOWER, 1111 MONUMENT CIRCLE, SUITE 3000, INDIANAPOLIS, IN, 46204, US

(21) Appl. No.: 10/687,500

(22) Filed: Oct. 16, 2003

Related U.S. Application Data
(60) Provisional application No. 60/418,944, filed on Oct. 16, 2002.

(51) Int. Cl. C08J 11/04; C08L 95/00

(52) U.S. Cl. 521/40; 524/59

(57) ABSTRACT

A system and method is provided for processing scrap FRP for use in the production of concrete or asphalt construction or paving material. In the process, the scrap FRP is comminuted, ground or pulverized into particle sizes suitable for combination with the base paving material. In one preferred embodiment, the scrap FRP is processed into particles of about ¼ inches in outer dimension. This processed scrap FRP is then mixed at the job site with other aggregate materials for combination with the base material to form a paving mixture that is applied to the prepared surface. In one embodiment, the scrap FRP material is passed through an industrial chipper or shredder and the comminuted particles are then combined with materials in a paving materials processing drum at the job site.

### CROSS REFERENCE TO RELATED APPLICATION

The present application claims priority to U.S. Provisional Application, Ser. No. 60/418,944, filed on Oct. 16, 2002, entitled “Environmentally Responsible Reuse of Waste Building Products”.

### BACKGROUND OF THE INVENTION

The present invention concerns systems and methods for recycling scrap fiberglass, and particularly scrap fiberglass products. The invention specifically contemplates systems and methods for using the recycled scrap fiberglass in aggregate-based construction products, such as concrete and asphalt.

A typical fiberglass material is composed of woven or non-woven fibers impregnated with a suitable plastic, such as a resin or a polymer. The impregnated material is poured, sprayed or otherwise applied to reinforcing and/or filler materials and permitted to harden into a structural member or product. Generally, one or both of the reinforcing material, filler material and/or hardenable material is/are relatively inert to the environment. Thus, decomposition of scrap fiberglass proceeds extremely slowly, it at all.

Fiberglass is a material of choice in the production of building components, such as tubs, sinks, shower stalls and the like. Moreover, fiberglass is an optimum material for vehicle parts and water craft due to its high strength to weight ratio. This material is also used for many sporting goods, such as hockey sticks and surfboards, for the same reason. Since fiberglass or fiber-reinforced plastic (referred to as FRP herein) is widely used, it goes without saying that FRP scrap is prevalent. In any production facility, a certain amount of product is scrapped because it is defective for one reason or another. When a house is remodeled or demolished, the FRP building components are scrapped. When an FRP component is damaged it is often irreparable, and consequently the damaged component becomes scrap. Even the manufacturing process for FRP products generates a significant volume of scrap FRP.

Heretofore there has been virtually no use for scrap FRP, which means that this vast quantity of FRP scrap must be disposed of in landfills. Since FRP is virtually immune to decomposition, overfilling of landfills becomes a very real environmental problem. Minimal regulatory attention has been focused on addressing the FRP disposal problem. However, some landfill owners require compacting of the FRP material to reduce its volume within the landfill.

As long as FRP remains a material of choice for building products, vehicles and other consumer products, the problem of disposing of FRP scrap will continue to grow. What is needed is a system and method for recycling scrap FRP.

### SUMMARY OF THE INVENTION

In order to address this need, the present invention contemplates a system and method for recycling scrap fiberglass, or FRP. In the preferred embodiment, the scrap FRP is processed for use in the production of concrete or asphalt construction material. In the process, the scrap FRP is comminuted, ground or pulverized into particle sizes comparable to the particle size of aggregates typically combined with the base construction material. In one preferred embodiment, the scrap FRP is processed into particles of about ¼ inches in outer dimension. This processed scrap FRP is then mixed at the job site with other aggregate materials for combination with the base construction material.

The present invention contemplates obtaining scrap FRP from a variety of sources. In one aspect, the scrap is obtained from a fiberglass production facility in the form of defective product or FRP residue. In another aspect, the scrap is obtained from a landfill facility where the FRP is separated prior to burying the waste in the landfill.

In a preferred embodiment, the scrap FRP is passed through an industrial chipper or shredder capable of reducing the scrap material to small particles. Preferably, the particles have a maximum outer dimension of about ¼ inches. Depending upon the nature of the scrap FRP, some preliminary processing may be necessary to reduce the material to a size and configuration amenable to further comminuting in the industrial shredder. For instance, where the scrap FRP is a boat hull, the large hull can be cut into strips or can be crushed so that the form of the hull is fractured. Similarly, where the scrap material is a bathtub of shower shell, preliminary processing may be necessary to produce scrap segments that can be easily fed into the industrial shredder.

In one embodiment, the shredded scrap FRP is produced in a centrally located facility. Where large quantities of shredded FRP material is desired, the material can be loaded into a hauling vehicle. Alternatively, the shredded FRP material can be loaded into large bags for convenient storage and transport.

In another embodiment, scrap FRP is shredded where the scrap is produced. Thus, the industrial shredder/chipper can be a portable unit that can be hauled to a particular job site. The comminuted scrap material can be loaded into bags or into a hauling vehicle as appropriate.

The processed scrap FRP is provided as a filler material for combination with asphalt or concrete building materials. More particularly, the processed scrap FRP can be combined with asphalt or concrete used in the laying of roadwork or surface paving. In a preferred application, the processed scrap FRP is added to the base material or aggregates combed with the base material, in a predetermined weight ratio. For instance, one to three pounds of comminuted scrap FRP can be added per cubic yard of concrete, or 4 tons of scrap FRP can be combined with 400 tons of asphalt.

It is contemplated with the present invention that the processed scrap FRP can be added to the paving materials at the job site. Thus, in one embodiment, the comminuted material is blown into the rotary processing drum during asphalt production. In another embodiment, the scrap FRP is combined with existing aggregate material combined with cement during a concrete paving process.

### DESCRIPTION OF THE FIGURES

FIG. 1 is a perspective view of an industrial chipper/shredder used in one embodiment of the invention to process scrap FRP.

FIG. 2 is a side detail view of the shredding elements of the industrial chipper/shredder shown in FIG. 1.

FIG. 3 is a representation of one system for introducing scrap FRP processed in accordance with the present invention into a road material production facility.

### DESCRIPTION OF THE PREFERRED EMBODIMENTS

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

In accordance with the present invention, scrap fiberglass or FRP material is obtained from a variety of sources. One common source is the manufacturer of FRP products, ranging from fiberglass boat hulls to FRP bathtubs. The scrap FRP material generated by such a manufacturer includes drippings or flash residues that arise in the spraying or molding process. This residue can be easily swept into a container or hauling vehicle for further processing substantially as is. However, additional scrap material is in the form of a defective product that might result from an incomplete spraying operation. The scrapped product is not as easily manipulated as the FRP residue material. While the scrap product may be small enough to carry in a container or hauling vehicle, it is preferable that this type of scrap be pre-processed. In this pre-processing, the defective product is cut into more manageable pieces, such as long, narrow strips. In a most preferred embodiment, the strips can be about 3 inches wide. These strips can be cut using a hand-held power saw. Alternatively, for larger scrap product, such as a boat hull, the defective product can first be crushed or pulverized to facilitate cutting the product into strips.

In the next step of the inventive process, the scrap FRP is comminuted or ground into small particles. This step can be performed by a wet grinder, a chipper/shredder, or the like. In one specific embodiment, a commercially available 3 inch wood waste chipper was used. To reduce dust generation, a garden hose with its nozzle set to a fine spray was directed to continuously dispense water into the chipper. In this specific embodiment, the scrap material was passed through the chipper multiple times until the desired particle dimension was achieved.

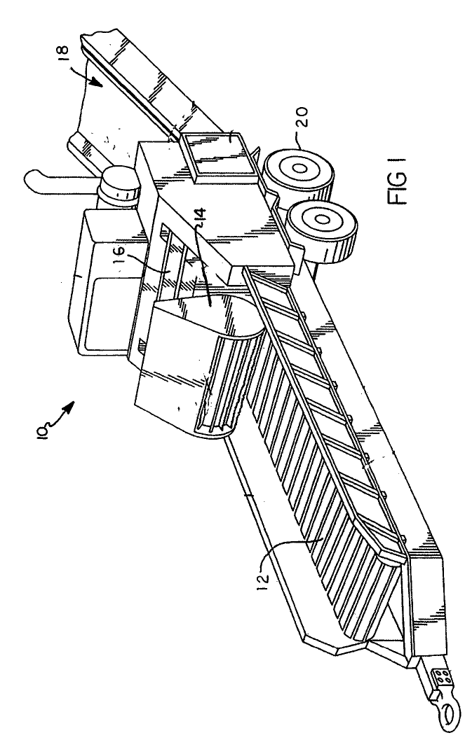

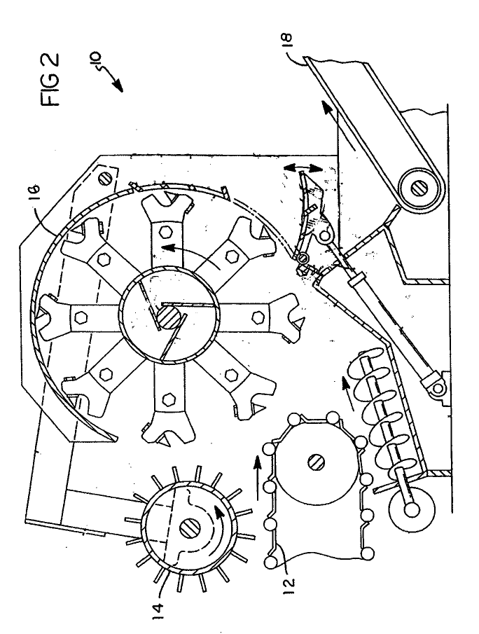

In another embodiment, the scrap material is fed through an industrial chipper/shredder, such as the apparatus shown in FIG. 1. This particular apparatus is shown and described in U.S. Pat. No. 5,863,003, issued on Jan. 26, 1999, which patent is incorporated herein by reference. This apparatus is embodied in a commercial product designated the “Model 3680 Beast Recycler” horizontal feed cutter mill and produced by Smoracy, LLC. As shown in FIGS. 1 and 2, the apparatus 10 includes a feed conveyor 12 on which the input scrap FRP is placed. A feed wheel 14 directs the scrap material into the cutter mill 16 where a plurality of teeth severs or comminutes the input material. The processed material exits the cutter mill onto a discharge conveyor 18. As shown in FIG. 1, the discharge conveyor carries the comminuted scrap FRP upward to be dropped into a suitable container or hauling vehicle.

As can be seen in FIG. 1, the apparatus 10 includes wheels 20 so that the apparatus can be towed from site to site. In a preferred embodiment of the invention, the scrap FRP is processed at the location of the scrap. Thus, the apparatus 10 can be towed to a fiberglass manufacturing facility, to a waste disposal facility or to a landfill where the scrap FRP can be processed. Preferably, where the processing occurs on-site, the comminuted material is discharged into a hauling vehicle. The hauling vehicle can then travel directly to a job site or can carry the material to a distribution center. The comminuted scrap FRP can be stored in storage bins or silos, or can be distribute into containers or bags. Since the FRP is relatively immune to decomposition, long term storage of the comminuted material should pose few maintenance problems.

One focus of the present invention is the use of the comminuted scrap FRP material in the preparation of surfacing material, such as concrete or asphalt. In both paving approaches, the base material (cement or asphalt emulsion) is mixed with a particulate aggregate material typically suited to increase compressive strength of the paving layer. For instance, a common aggregate used in concrete paving includes gravel or sand.

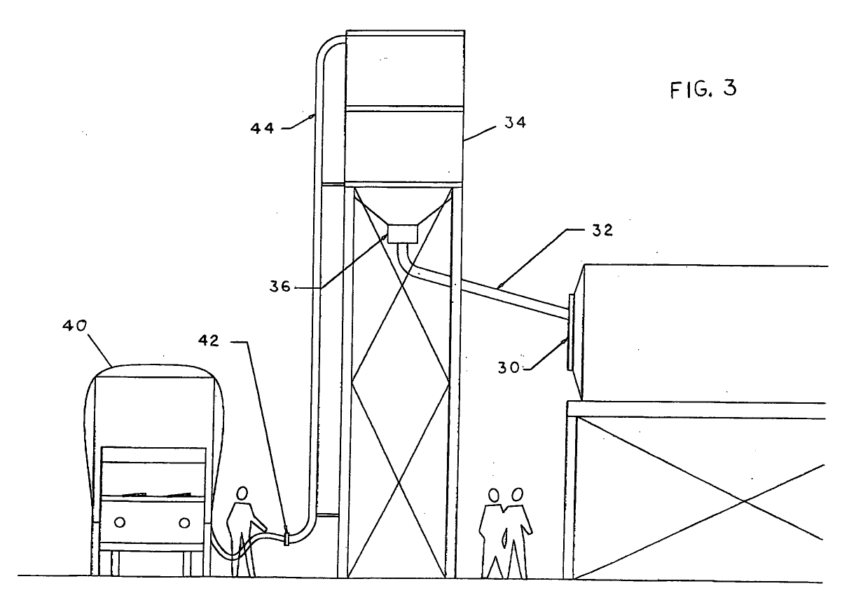

In accordance with the present invention, the comminuted scrap FRP is preferably mixed with the aggregate as the concrete is being mixed. A typical system for integrating the scrap FRP with the aggregate is illustrated in FIG. 3. The system shown in this figure represents a standard jobsite concrete production facility that includes a concrete mixing drum 30 that receives aggregate through a supply chute 32. The aggregate is stored in a hopper 34 and fed to the chute 32 through a metering gate.

In accordance with the present invention, a supply of comminuted scrap FRP is carried by a hauling vehicle 40 to the jobsite. The hauling vehicle is provided with a feed nozzle 42 that can mate with a supply conduit 44 to pump the scrap FRP into the hopper 34. In order to ensure mixing of the scrap FRP with the aggregate, the hopper or metering gate can include an agitation mechanism. Alternatively, the scrap FRP can be mixed within the rotating mixing drum 30, although this approach is believed to be less optimum. The volume of comminuted scrap FRP fed into the hopper 34 can be calibrated to the quantity of concrete being produced and to the volume of other aggregate material being mixed. In a specific embodiment, one to three pounds of comminuted scrap can be provided per cubic yard of concrete produced. It should be understood that the comminuted scrap FRP can replace a like quantity of aggregate that would otherwise be mixed with the cement to form the concrete product. It has been found that substituting the scrap FRP for some portion of the aggregate material does not adversely the compressive strength of the concrete, which is the critical strength component of this material when used as a paving surface.

The present invention also contemplates combining comminuted scrap FRP with asphalt materials. In a typical on-site asphalt production facility. The aggregates, emulsifying agents and other constituents are mixed in a rotating drum. Thus, an arrangement similar to that shown in FIG. 3 can be used. In an alternative approach, an industrial blower can be used to blow the comminuted scrap FRP particles into the rotating drum. In a specific embodiment, an insulation blowing machine, sold as the “Volu-Matic IV” model by Unisol Corp., can be used to blow the comminuted FRP directly into the rotating asphalt process drum. This model machine can run off a vehicle power take-off, so it can be readily moved from jobsite to jobsite. In other embodiments, the scrap FRP can be fed into the rotating drum by an auger feed conveyor, along with other aggregates being combined to produce the paving grade asphalt.

As with the concrete production, the ratio of comminuted scrap FRP to the output asphalt product can be varied depending upon the desired physical properties of the asphalt. In a specific embodiment, 4 tons of comminuted scrap FRP is combined per 400 tons of asphalt output product. The scrap particles can be combined on a 1-2% ratio by weight. In a typical asphalt paving operation, two layers of asphalt are laid—a cold mix bottom layer and a hot mix top layer. In the most preferred embodiment, the comminuted scrap FRP is combined with the asphalt materials for the cold mix layer only. The hot mix upper layer will cover any scrap particles exposed at the surface of the cold mix layer so that the resulting paved surface will be smooth and uninterrupted.

In the described embodiments, the scrap FRP material is chipped or shredded into particle sizes of about ¼ inch in outer dimension. This particle size can be modified depending upon the particular concrete or asphalt mix. Nominally, the size of the comminuted FRP particles should approximate the size of other aggregates being combined with the base material to form the paving material. However, it is important that the comminuted FRP material have an outer dimension that is suitable for mixing with paving materials and that is suitable for use in a paving operation. It should be understood that comminuted materials having too large an outer dimension may be exposed when the paving material is applied. Moreover, comminuted scrap FRP that is too large can compromise the structural integrity of the paved surface. Thus, the comminuted FRP particles have an outer dimension of no more than 1 inch, and most preferably no more than ½ inch

Since the comminuted material is formed from fiberglass or FRP, the resulting particles will be extremely lightweight relative to the aggregates and other components combined to form the paving surface. The light weight of these particles can facilitate storage and transport of the processed material. On the other hand, the weight of the comminuted particles relative to the weight of the aggregate material may make mixing problematic. Thus, while the processed scrap FRP can be combined with concrete aggregate in the production of paving concrete, maintaining a homogeneous mixture of these particulate components is complicated by the large particle weight difference. In these instances, an auger feed arrangement may be preferable with the aggregate and the comminuted scrap FRP be provided in separate inputs to the auger conveyor. In the production of asphalt, the use of a blower to blow the comminuted FRP particles into the rotating drum may be preferable and may provide for more complete mixing of the particles within the finished asphalt product.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

What is claimed is:

1. A process for recycling scrap fiber-reinforced plastic (FRP) comprising the steps of:
obtaining scrap manufactured FRP components or products;
processing the scrap FRP components or products to form FRP particles having an outer dimension suitable for combination with paving materials for use in paving;
combining the FRP particles with a paving material to form a paving mixture; and
processing the paving mixture for application to a surface.

2. The process for recycling scrap FRP of claim 1, wherein the step of obtaining scrap manufactured FRP components or products includes obtaining residual material resulting from an FRP manufacturing process.

3. The process for recycling scrap FRP of claim 1, wherein the step of obtaining scrap manufactured FRP components or products includes obtaining defective products resulting from an FRP manufacturing process.

4. The process for recycling scrap FRP of claim 1, wherein the step of obtaining scrap manufactured FRP components or products includes obtaining such components or products from a landfill facility.

5. The process for recycling scrap FRP of claim 1, wherein the step of processing the scrap FRP components or products includes comminuting such components or products.

6. The process for recycling scrap FRP of claim 5, wherein the step of processing the scrap FRP components or products includes passing such components or products through a chipper or shredder.

7. The process for recycling scrap FRP of claim 6, wherein the step of processing the scrap FRP components or products includes pre-processing such components or products prior to comminuting to reduce such components or products to a size capable of being fed into such chipper or shredder.

8. The process for recycling scrap FRP of claim 7, wherein the step of processing the scrap FRP components or products includes pre-processing such components or products by cutting such components or products into strips sized to be fed into such chipper or shredder.

9. The process for recycling scrap FRP of claim 1, wherein the step of processing the scrap FRP components or products includes forming particles having an outer dimension of no greater than one (1) inch.

10. The process for recycling scrap FRP of claim 1, wherein the step of processing the scrap FRP components or products includes forming particles having an outer dimension of no greater than one half (½) inch.

11. The process for recycling scrap FRP of claim 1, wherein the step of processing the scrap FRP components or products includes forming particles having an outer dimension of no greater than one quarter (¼) inch.

12. The process for recycling scrap FRP of claim 1, wherein the step of combining the FRP particles with a paving material includes blowing such particles into a rotating drum containing the paving material.

13. The process for recycling scrap FRP of claim 1, wherein the step of combining the FRP particles with a paving material includes mixing such particles with paving material in a hopper.

14. The process for recycling scrap FRP of claim 1, wherein the paving material is mixture is concrete.

15. The process for recycling scrap FRP of claim 1, wherein the paving mixture is asphalt.

16. The process for recycling scrap FRP of claim 1, wherein the surface is a driving surface.

17. The process for recycling scrap FRP of claim 16, wherein the obtaining and scrap FRP processing steps occur at a location remote from the site of the driving surface and the combining step occurs at the site of the driving surface.

18. The process for recycling scrap FRP of claim 1, wherein the scrap FRP processing step occurs at the site of the obtaining step.
